(19) United States
(12) Patent Application Publication
(10) Pub. No.: US 2014/0168412 A1
(43) Pub. Date: Jun. 19, 2014

(54) METHODS AND SYSTEMS FOR AUTOMATED MICRO FARMING

(71) Applicants: Alan Shulman, Santa Rosa, CA (US); Miles Scott, Indianapolis, IN (US)

(72) Inventors: Alan Shulman, Santa Rosa, CA (US); Miles Scott, Indianapolis, IN (US)

(21) Appl. No.: 14/135,363

(22) Filed: Dec. 19, 2013

Related U.S. Application Data
(60) Provisional application No. 61/739,357, filed on Dec. 19, 2012.

(51) Int. Cl. H04N 7/18

(52) U.S. Cl. CPC H04N 7/18
USPC 348/89

(57) ABSTRACT

System and methods for farming of crops on a plant-by-plant basis are disclosed. Plants are imaged and data is acquired on a plant-by-plant basis, which enables the visual micro management of a crop field on a plant-by-plant basis. Past and current images of a plant may be displayed in a manner that allows plants to be diagnosed and maintained. In some embodiments, images of an individual plant and instructions for maintenance are automatically displayed to a field work in real-time as the worker is in the proximity of the plant. Techniques described herein can be used in the field or during the harvest process including sorting tables or sorting conveyor belts. This can be done via signage, bar codes or RFID tags or other unique plant identifier technique. This approach compresses the acquired data and automatically selects and displays relevant information to a specific fruit or plant.

### CROSS-REFERENCE TO RELATED APPLICATIONS

The present application claims the benefit of priority of U.S. Provisional Application No. 61/739,357, filed Dec. 19, 2012, entitled “METHODS AND SYSTEMS FOR MICRO FARMING,” the disclosure of which is expressly incorporated herein by reference in its entirety.

### FIELD

The present disclosure relates generally to methods and systems for practical micro farming.

### BACKGROUND

Traditional methods of cultivating and maintaining crops, from year to year, require a farmer to have detailed knowledge of their fields including areas of superior harvest yields or areas most likely to have disease problems such as mold. Such parameters are normally committed to human memory or occasionally archived as data points. This approach requires an individual to remember technical details regarding which areas of the field require more water, fertilizer, and/or other requirements in order to maximize the yield of the crop. Sometimes it is important to compare the same plant to itself over a period of time to establish growth rates. Unless a farmer has photographic memory this kind of comparative analysis cannot be done by a human. Other information not discernable to a farmer's eyesight include visible and non-visible information such as near or infra-red reflections or fluorescence which has been shown to provide valuable qualitative assessments of the health of a crop. Recent research have detailed the uses of various reflection and fluorescence studies in narrow spectral bands to provide biologic parameters such as mold infections, chlorophyll health and determine optimal harvest conditions. These visual studies require using optical biological properties using sensors or cameras that can determine which plants: are molding, are receiving too much sunlight, not receiving enough water, or require fertilizer or need to be harvested as they are at their peak ripeness. The current approach is usually limited to human visual inspection, or strategies that involve selective sampling and the use of costly lab tests. Some tests are destructive, requiring that the plant be harmed or sacrificed to measure its internal chemistry. This approach also requires a farmer to test a subset of a field of plants, and use the results of the samples to generalize the information to a larger area. This approach therefore does not provide an accurate representation of all of the plants in the field.

Furthermore, existing sampling techniques sometimes require an individual to use visual cues to determine if microscopic testing is warranted, which can be misleading. If, however, farmers wait until mold is visible before testing, massive crop losses can occur due to delayed treatment.

Hardware and software solutions exist that can enable a user to detect plant ailments, pestilence, and/or physical damage, before it can be detected by the human eye. Cameras and sensors can monitor the internal chemistry of crops and 24/7 weather sensor databases provide real world environmental histories that offer more precise and responsive farming techniques. Timely remediation or response to detected conditions can be accurately delivered and monitored on a plant-by-plant basis. Optimal harvest conditions such as ripeness, hydration, minimal use of pesticides in response to disease infestation, minimal use of fertilizer applications and immediate response to plant stress can minimize costs, save entire harvests from losses and improve crop quality and yields and profits. For wide-scale application of such measures on a plant-by-plant basis, however, the information needs to be efficiently organized and made available to the farmer in a useful and practical manner and presented in the field or where farming tasks can be performed.

### BRIEF DESCRIPTION OF THE DRAWINGS

FIG. 1 shows a block diagram illustrating an exemplary system for performing micro farming consistent with the present disclosure.

FIG. 2 shows a flowchart illustrating steps in an exemplary method for performing micro farming consistent with the present disclosure.

FIG. 3 is an exemplary image of a user acquiring or displaying a picture of a plant and plant identifier using a mobile computing device.

FIG. 4A is an exemplary image of a computing device displaying a base image of a crop and a spectral image of the crop.

FIG. 4B is an exemplary image of a computing device displaying a base image of a crop, spectral image of the crop, and a superimposed image of the two images.

FIG. 5 is an exemplary image of a user viewing a crop on a sorting device such as a sorting table or conveyor belt and a projected biological study image of the crop through a partial mirror.

FIG. 6A is an exemplary image of a computing device displaying an image of a cluster of plants in a field.

FIG. 6B is an exemplary image of a computing device displaying an image of an individual plant with a plant identifier.

FIG. 7 is an exemplary image of a computing device displaying an image of a plant with icons displayed on the image of the plant.

FIGS. 8A-8C are several views of an exemplary image of a mobile computing device obtaining a picture of fruits at a point of sale produce market.

### DETAILED DESCRIPTION

The present disclosure relates generally to methods and systems for practical micro farming that can visually present in a meaningful way to a farmer the vast amount of data that is generated by geo-located sensor information and image processing information. A “farmer” may not be able to comprehend nor practically utilize the large amounts of data that can be generated by recent developments in sensor technology. The automatic visual display of the information in context with real world pictures of his crops as seen in the field or during harvest processes presents the farmer with immediate easy to understand techniques to readily use vast amounts of available data.

Methods and systems described herein enable micro farming to be done on a plant-by-plant basis. In general, the inventions disclosed herein utilize novel acquisition and display techniques that present data on a plant-by-plant basis, thereby enabling practical in-field or during-harvest processing such as sorting micro-management of a crop field on a plant-by-plant basis. The collected data is displayed in a real time way that visually associates biological assessments and parameters to the actual plant or harvest product. The novel display approaches involve the acquisition or rendering of information congruent with a farm worker's point of view as it is presented in the field or during the harvest process including sorting tables or sorting conveyor belts.

In certain embodiments, the acquisition camera point of view is similar or congruent with the line of sight a farmworker would have while in the field working on a specific plant.

Imagery data can be remotely acquired and subsequently displayed, collated, correlated, rendered and/or compared to a current condition by using a geolocation plant identifier data indexing technique. The plant identifier can be the row and plant number and in some instances can be associated with a longitude and latitude position. Individual plant identification using RFID tags or simple identification numbers or bar codes can also be used to recall data for each plant that can be done by simple image analysis of an acquired image containing the identifier. The signage itself, such as a barcode can include test pattern fiduciary points that can be used to assist with image registration and resizing. Imaging techniques now include the ability to read license plate numbers for example. These similar visual or electronic techniques will be used to trigger the acquisition and/or archiving of data with a specific plant. The device and display processes can use visible and non-visible sensor images and data that can include plant response time to external lighting stimuli. In some embodiments spectral filtering techniques can be used along with image processing to assess plant qualities and characteristics. These spectral techniques have been well researched and identified for many years. A better technique is to present and utilize this information in a practical manner that is achieved by the automated recall of the information that is selected on a plant-by-plant basis. Displaying a an image that includes assessment data onto a fruit sorting table, as an individual is trying to sort fruit quality provides an intuitive understanding and more useful presentation of the data as opposed to numbers. These methods and systems can display information real time on a display or even project information onto actual crop products or plants using digital or optical techniques and recalling the correct plant information automatically as one views a plant or crop. In some embodiments see through displays or personal eyewear can be used to create an augmented reality.

Comparative relative spectral values can be used rather than specific absolute values associated with a plant's biological characteristic parameter such as sugar levels or chlorophyll health. Relative values rather than absolute values are easier to calculate and do not require consideration of complex mathematical environmental variables such as varying amounts of sunlight, time of day, air, or temperature. The plants that are reflecting the most amount of green reflected light in the peak green band for example may have better photosynthesis biological characteristics than plants reflecting less green. The absolute value of the chlorophyll may not be as important to a farmer as the relative identification by comparison of which plants have less amounts of chlorophyll than others that the farmers knows is optimal. The laboratory absolute assay value of the chlorophyll is not required. The utility of imaging and characterizing each plant on a farm has not been widely adopted due to the large data sets generated and processing power required and labor. To reduce the processing required and mitigate some of the environment variations, the relative comparisons rather than absolute comparisons can be done with much higher fidelity. The addition of image processing techniques along with a visual display to rectify remote sensor or image data with video imagery can assist with rapid decision making tools. For example the culling of grape clusters that have reduced biological qualities is a routine procedure during the growing season. An infield viewing technique enables the immediate and accurate assessment of which grape clusters to cut. Currently, only generalized instructions are given to a farmworker.

Methods and systems described herein also enable consumers with mobile devices to determine a certain fruit parameter (e.g. senescence or decay) by utilizing the camera flash and specific filters over the lens or flash, along with image processing techniques presented in an application running on the mobile device to visually display certain biological characteristics corresponding to the desired fruit parameter.

Reference will now be made in detail to embodiments, examples of which are illustrated in the accompanying drawings. Wherever possible, the same reference numbers will be used throughout the drawings to refer to the same or like parts.

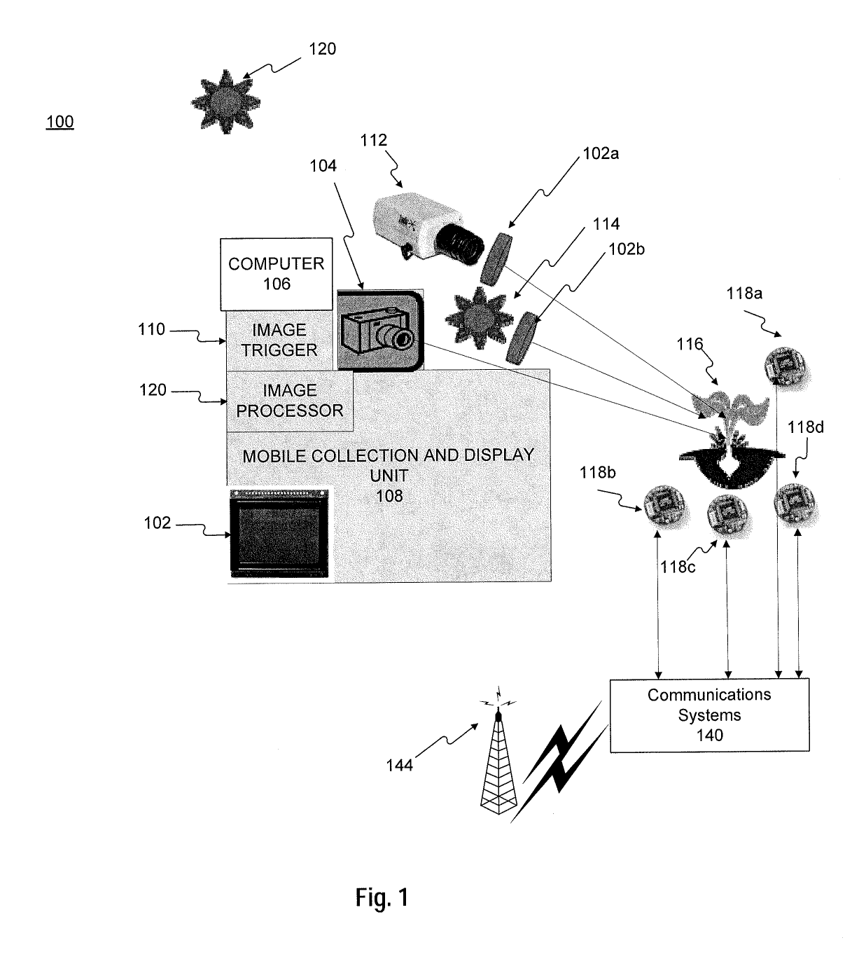

FIG. 1 shows a block diagram illustrating components in system 100 for an exemplary system for performing automated micro farming consistent with the present disclosures. As shown in FIG. 1, system 100 comprises a camera (104 and/or 112), a mobile collection unit 108, and computer 106.

Mobile collection unit 108 may be, for example, a vehicle capable of traveling in the field, such as an all-terrain vehicle (ATV) or autonomous robot. In some embodiments, the mobile unit 108 may be a manned or unmanned aerial vehicle (UAV), commonly known as a drone.

Mobile collection unit 108 may be outfitted with an onboard computer that comprises a processor and memory (not shown). In certain embodiments, the mobile collection unit 108 may acquire images from a database stored in onboard memory or wirelessly from a remote storage location. In some embodiments, mobile collection unit 108 processes the received images. In some embodiments, mobile collection unit 108 only collects the data and transmits the data wirelessly to another location for storage or processing.

Mobile collection unit 108 can also contain a display 102. Display 102 may be used, for example, to display images acquired, collected, or processed to a human operator of to monitor the images being acquired by spectral camera 112 and camera device 104. Mobile collection unit 108 can have image processing capabilities to register and render images from on board archives and current images, perform image transformations that can include subtraction and threshold techniques.

In some embodiments, mobile collection unit 108 may be a mobile phone, tablet, laptop, or other mobile processing device with a camera and processing capability.

System 100 comprises a means by which a plant's location may be determined. In some embodiments, mobile collection unit 108 may be equipped with a device, such as an image trigger 110. Image trigger 110 can be, for example, a device comprising a memory and processor, that can begin taking images of a plant after a plant identifier has been recognized/registered by the processor. An image trigger is a signal created in response to a physical event such as a button push or detection of proximity to a plant identifier. An image trigger will actuate the camera to take a snapshot at a point in time or and image trigger will identify which frame to archive as a camera is running. An image trigger device receives image trigger signals and can select which frame in a ring buffer is archived. An image trigger can also select which frame in a database is called for viewing or processing. Alternatively, in some embodiments image trigger 110 can archive an image, or multiple images, of a plant from a continuous video feed produced by cameras 104 or 112 after a plant identifier has been recognized/registered by the processor. In other embodiments, system 100 may be able to determine the geolocation of the plant by automated location techniques such as RFID tags, bar codes, emitted electronic signals, or simple signage that may indicate the geolocation of the plant with text or image. In certain embodiments, system 100 may use object identification techniques implemented in software to determine the object and the location. In some embodiments, an individual plant's geolocation may be determined based on its relationship or proximity to other plants with a known geolocation.

In certain embodiments, system 100 can comprise optional sensors 118 a-d for collecting environmental data, which may be a single sensor or a plurality of sensors. In many embodiments, the sensors are solar-operated so as not to need power in the field or replacement of batteries. Sensors can be equipped with a radio-frequency module that allows the sensor to send and receive wireless transmissions. At least one of sensors 118 a-d may transmit geolocation information. One or more of sensors 118 a-d can be a weather station. Sensors 118 a-d can be wired or wirelessly connected to a communication system 140 that aggregates data. In some embodiments the aggregated data can be sent to mobile collection unit 108 using WAN 144. The particular design of communication system 140 may depend on the wireless network in which sensors 118 a-d are intended to operate. Sensors 118 a-d can send and receive communication signals over the wireless network to mobile collection unit 108 after the required network registration or activation procedures have been completed.

In some embodiments, mobile collection unit 108 may have an LED spectral emission unit 114, which may be mounted on mobile collection unit 108 or otherwise configured to move with mobile collection unit 108 and transmit electromagnetic waves that illuminate plants as the vehicle moves. Spectral emission unit 114 can be operated with or without a filter (such as filter 102b). Filter 102b may optionally be used to limit certain frequencies and wavelengths of the transmitted electromagnetic wave to be reflected from the plant.

In certain embodiments, spectral camera 112 may be mounted on mobile collection unit 108, or otherwise configured to move with mobile collection 108, to take images of plants as the vehicle moves. In some embodiments, the system archives only one image, or “frame”, of each plant to minimize the size of the database. In other embodiments, multiple images per plant may be stored. In certain configurations, an external filter 102a can be used with spectral camera 112 to limit certain frequencies and wavelengths of the electromagnetic wave reflected from the plant to pass through to spectral camera 112.

A camera device 104 and/or 112 can be mounted on, or otherwise configured to move with, mobile collection unit 108 and can take images of plants as the vehicle moves in proximity of a plant identifier. Spectral camera 112 can capture the reflectance, thermal images, and/or fluorescence qualities of a plant. The cameras can be running at any frequency, but the trigger technique selects which frames are archived. In certain embodiments,

While camera device 104 and spectral camera 112 can be mounted anywhere on mobile collection unit 108, in at least one embodiment camera device 104 and/or spectral camera 112 are mounted in the same location with a field of view congruent with an individual standing in front of a plant. For example, the cameras can be mounted on the side of mobile collection unit 108 at a height and viewing angle that is equivalent to the height at which an individual would be pruning a plant in the field. In this instance the field of view of the image obtained by mobile collection unit 108 can be similar to the in field of view of an individual who is looking at a plant in the field, and receiving images from mobile collection unit 108 as they are pruning or adding chemicals to the plant. This ensures that the individual performs a plant maintenance task (i.e., farm worker task) correctly such as pruning.

In some embodiments, mobile collection unit 108 and one or more of cameras 104 and 112 may be located in one device, or be the same device, such as a camera-enabled smartphone, tablet, or laptop computer.

System 100 can also include computer image processor 120 which can be used to render and view images collected by mobile collection unit 108, sensor readings generated by sensors 118 a-d, images of plants collected by mobile computing devices used by an individual in the field, and or other information (e.g. weather forecasts) from the Internet. In some embodiments, image processor 120 may be configured to perform other types of image processing or comparison.

The systems and methods disclosed herein may be used to minimize the size of the database and micromanage each individual plant by using an acquisition technique to trigger the acquisition and or display of data automatically on a plant-by-plant basis, by identifying signage, bar codes, RFID tags, or other plant identifiers that are unique to each plant. These physical techniques will minimize errors and allow for simpler equipment to be used. Object identification software and or point cloud data can be used to identify individual plants and or infer their GPS position but will require substantial processing power and may not be as accurate. The changing imagery from a plant as it grows may generate errors if this approach is relied upon. Differential GPS is one method of providing the accuracy required to use GPS coordinates as the acquisition trigger but also requires very accurate x,y,z ego motion camera/sensor information. Uneven ground below the acquisition unit may add errors to the inferred plant position compromising the ego pointing information.

Farm management systems described herein use optical sensors and images, computing hardware and software to provide the farmer or related agricultural business with the ability to visualize valuable disease detection and provide crop management capabilities. Exemplary systems can be adapted to other kinds of crops and harvests, but are described here as a system for wine grape vineyards. Systems described herein can be used to identify diseases such as mold and other potential problems earlier, more quickly, more easily, and in more complete detail so that a more immediate and accurate response can be undertaken.

The system also allows better monitoring than previously available for fruit maturity, prevention of sun damage, optimal harvest time and more accurate indication on a plant-by-plant basis for irrigation and fertilization.

In general, systems described herein work by using specialized biological optical methods to capture an image of each plant in the vineyard. The system can detect issues needing attention and the vineyard manager can view each plant on screen to identify problems and make farming decisions and efficiently communicate these instructions to the farm worker. Images of the same plant taken during subsequent passes through the vineyard can show changes over time such as growth rates, providing additional information beyond what human memory allows.

In addition to individual plant images acquired by the system, the system can use satellite imagery available in the public domain to provide an overhead view of the vineyard and use these aerial overhead views to navigate to a specific plant in the database archive.

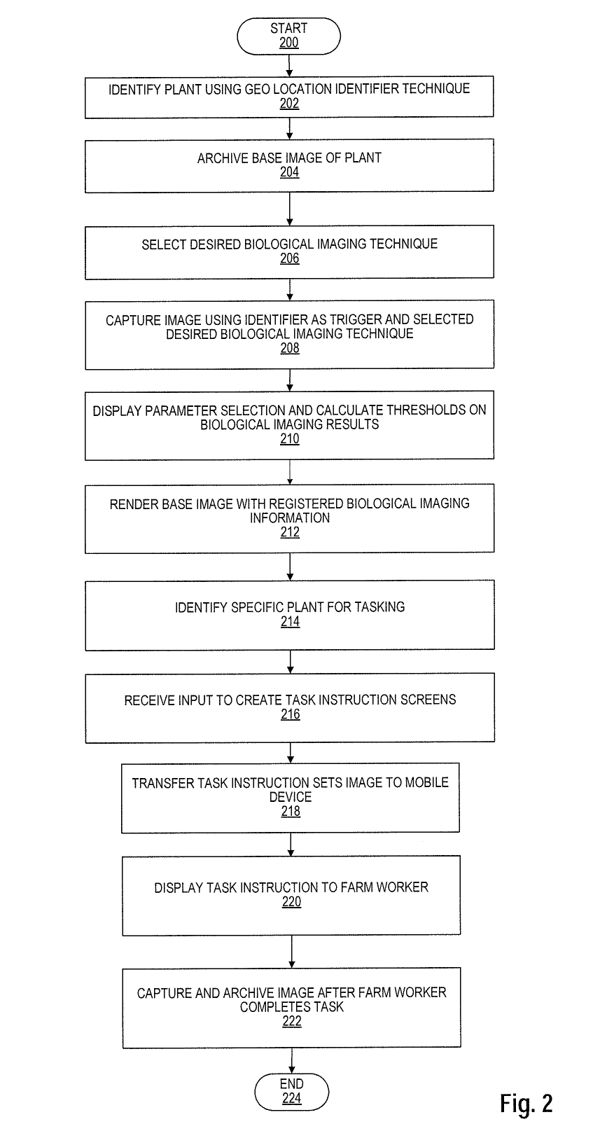

FIG. 2 shows an exemplary method for performing micro-farming consistent with the present disclosure. It will be readily appreciated by one of ordinary skill in the art that the illustrated procedure can be altered to delete steps, further include additional steps, or combine steps.

In step 202, an individual plant is identified. In embodiments herein, a plant may be identified by, for example, signage, bar codes or radio frequency identification (RFID) tags or other unique plant geolocation identifier techniques. In the case of RFID tags or signage, it is recommended that these are placed in the optical view of each plant so they are not obscured by plant growth. In some embodiments, plants are identified by object identification software and or point cloud data. The identification will usually include row and plant number and optionally can be associated with longitude and latitude.

In step 202, the location of the individual plant is determined, using a plant identifier placed in the field of view. The location of the plant may be determined by for example by scanning an RFID tag or bar code or other electronically or camera-recognizable plant identifier that is placed in proximity to a plant. In some embodiments, a human worker may input an identifier on a physical tag or location from signage (e.g. Row 57, Plant 9) to an onboard computer. In some embodiments, the collection and or archiving or display of data from an individual plant is triggered by a sensor detecting the proximity of the plant identifier.

In step 204, a base image of an individual plant is captured. The base image of the plant may be collected by, for example, a color camera. In certain embodiments, the base images of plants are collected via specialized camera equipment mounted on mobile vehicles, such as mobile collection unit 108 as described with respect to FIG. 1. In some embodiments, the camera can acquire one image, or “frame”, of each plant and the image is associated with the location identifier of the plant. This compression technique minimizes database size and allows for easy retrieval of information. In other embodiments, the camera may acquire more than one image per plant.

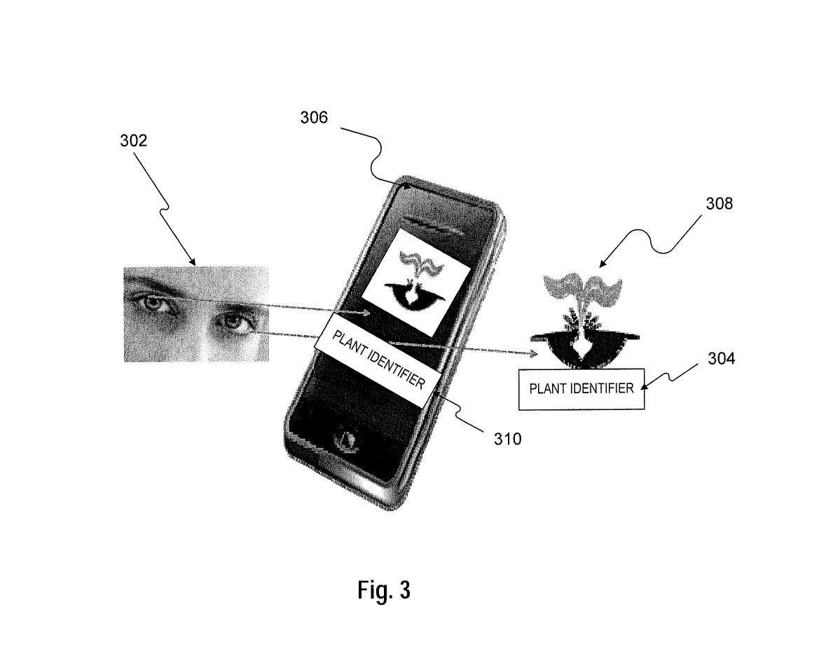

FIG. 3 is an exemplary image of a mobile computing device 306 either displaying a current image of a plant or displaying an archived image of a plant 308 which corresponds to plant identifier 304. In some embodiments mobile computing device 306 can download one or more of a base image of a plant, a corresponding spectral image of the plant, and a superimposed image of the base image and spectral image from computer 106 for plant 308 based on plant identifier 304. In other embodiments, mobile computing device 306 can take a picture of a plant corresponding to plant identifier 304, and compare the image to the image downloaded from computer 106.

In certain embodiments, the data collected by the field computer is stored locally on mobile collection unit 108. In other embodiments, the data collected by the field computer is uploaded to, for example, a server at another location or a server in the cloud. The images may be stored in any storage location that is accessible to the processor that will process the images. The image or images will be associated with one plant identifier or location. In some embodiments, the base view image is the most recently acquired full-color image. Images may be archived by a location identifier. The most recently acquired image can be an image acquired by a mobile device used by a farm worker, or an image acquired by mobile collection unit 108.

In certain embodiments, the base image is captured from the point of view congruent with a farm worker's view. This enables a farmer not located in the field, but perhaps viewing the images remotely, to have the same view of a plant that a farm worker in the field, and thereby enabling the remote farmer to send appropriate instructions to the farm worker in the field.

In step 206, a biological parameter imaging technique can be selected for a desired condition using reflectance, thermography, and/or fluorescence in step 206. Fluorescence studies may require reduced ambient light which can be achieved at night or with a hood or shading apparatus over the plant. The electromagnetic waves used to measure reflectance, thermography, and/or fluorescence can be generated by a spectral emissions unit, and a camera can be used to capture images of the reflectance, thermography, and/or fluorescence response of the plant. In certain embodiments, an electromagnetic spectral filter can be placed in the optical path between the imaging sensor in the camera, and the plant, to best acquire narrow band spectra reflections and fluorescence data. Alternatively, a filter can be placed in front of a light source when all other light sources have been diminished such as at night time. In yet other embodiments, the images generated by using the alternative imaging techniques can be acquired during the day with use of a shading hood over the crop or harvest. In some embodiments, the biological imaging technique may be automatically chosen or may be chosen by a user

After the desired biological imaging technique has been selected, in step 208, a camera device will capture images of the plant. In some embodiments, a plant identifier can trigger a camera to take and/or archive images. In some embodiments, a camera in, for example, a mobile collection unit captures images continuously or periodically or only when the mobile collection unit crosses the field of view of a plant identifier. In some embodiments a sensor within the camera is always on and creating frames, but the plant identifier can trigger the selection and archiving of a specific image. In some embodiments only one image is captured, yet in other embodiments several images can be captured to provide a “stitched” panoramic view of the plant, and the environment around the plant. A plant identifier will also cause the field unit to display one or more of a specific plant's archived images. In some cases, the plant identifier will cause the display of the associated plant's last archived image. In some embodiments only one image is captured, yet in other embodiments more than one image can be captured to provide a panoramic view of the plant, plant row, and other environmental aspects around the plant.

In step 210, the desired biological imaging parameters can be displayed and the biological imaging result thresholds can be calculated. In some embodiments, the comparative thresholds can be a certain color corresponding to a color code, for example grey levels. Previous archived images for a particular plant can be accessed and the highest and lowest color values can be obtained for the plant and an individual scale can be created for that plant. In some embodiments the scale can be divided based on different shades of color. Different scales can exist for example time of year in the growing season or plants receiving the most amounts of accumulated light. Yet in other embodiments the scale generated for an infected plant can be used as a baseline for determining if other plants are infected. In some cases, step 210 may be performed a priori, and stored thresholds may be used.

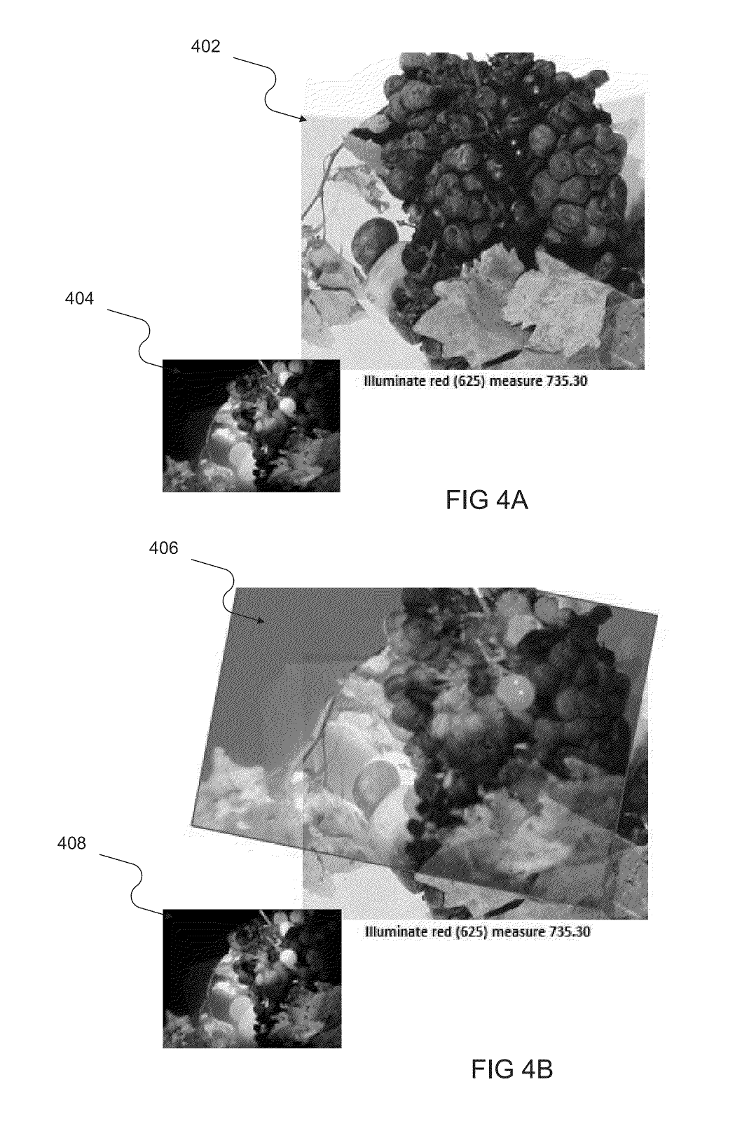

After thresholds have been established, in step 212, an image is rendered comprising a base image of the plant as captured in step 204 and the image of the plant as captured in step 208. The rendered image can be a superimposed image comprising the base image and the image of the illuminated plant, as shown in FIG. 4B, or the rendered image can comprise the two images side by side, as shown in FIG. 4A.

FIG. 4A is an exemplary image of a device displaying a base image 402 of grapes. In some embodiments the base data image can be a plant, vegetable, or another type of fruit. Image 404 is a spectral image of base data image 402. Spectral image 404 can be generated using the methods and systems described herein.

FIG. 4B is an exemplary image of a device displaying a base image of a crop and a spectral image of the crop. Image 406 is a superimposition of base data image 402 and 408. Image 408 is a spectral image of base data image 402. Image 406 can be generated using the methods and systems described herein.

Using images such as those in FIGS. 4A and 4B, systems described herein can compare images of a plant with archived data for that plant. The system may compare the images using one or more parameters, which may be pre-determined or pre-set or, in some embodiments, chosen by a user from a predetermined set. The predetermined parameters can include the yield at harvest time or at the same point in time in the previous year. It can include plant growth rates in the previous year at the same day growing cycle. It can include a comparison of hydration or anthocyanin level in a plant to the previous season. It can further include comparing the: flavonoid, acidity, brix/sugar, chlorophyll, carotenoid, water stress, nitrogen deficiency, gaseous pollutants, fungal infections, viral infections, and/or senescence levels from the previous year.

In step 214, a specific plant can be identified for tasking. In certain embodiments, one or more plants may be displayed on a screen and a user may choose a specific plant by interacting with the display or mobile device. In some embodiments, only one plant is displayed and the individual plant is then selected for tasking.

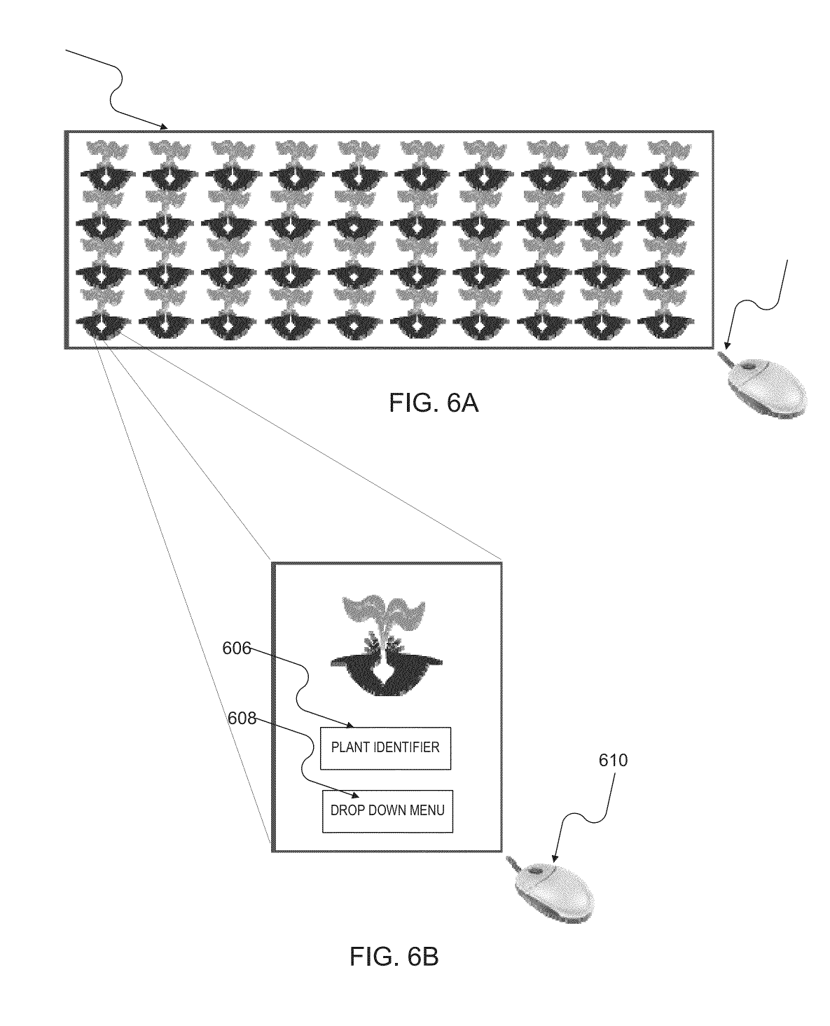

A base image can be selected and displayed on a computer screen as shown in FIGS. 6A and 6B. FIG. 6A is an exemplary image of a device displaying an image of a cluster of plants in a field for interrogation by a farmer. Device 602 can receive input from an operator to select a certain plant, or to select certain parameters associated with a plant, or to perform comparisons between the most recent plant data and archived plant data. For example, an operator can select a subset of the plants displayed on the screen and compare that subset to the same, or a different subset of plants, from the previous harvest. In other embodiments the computing device can compare the growth of a subset of plants to the growth of the same subset, or another subset, in the previous season. Yet in other embodiments, the computing device can display which portions of a field provide the best yield, which plants currently may have mold growing, which plants are receiving the most sunlight etc.

FIG. 6B is an exemplary image of a device displaying an image of an individual plant with a plant identifier, and drop down menu. FIG. 6B is a display generated after device 602 has received an input from device 604 indicating a selection of a certain plant. The selected plant is displayed on device 602. Plant identifier 606 can be, for example, the row and plant number and in some instances can also be associated with a geolocation position. A drop down menu 608 can be displayed on device 602 after input has been received to select a certain plant. Device 602 can display in drop down menu 608: the yield at the previous harvest for the plant, growth of the plant the previous year to date in the growing cycle, comparison of current hydration levels to archived hydration levels, comparison of current mold level parameters to archived mold level parameters, a comparison of anthocyanins, flavonoids, acidity, brix/sugar, chlorophyll, carotenoids, senescence, water stress, nitrogen deficiency, gaseous pollutants, fungal infections viral infections to previous archived data for the plant.

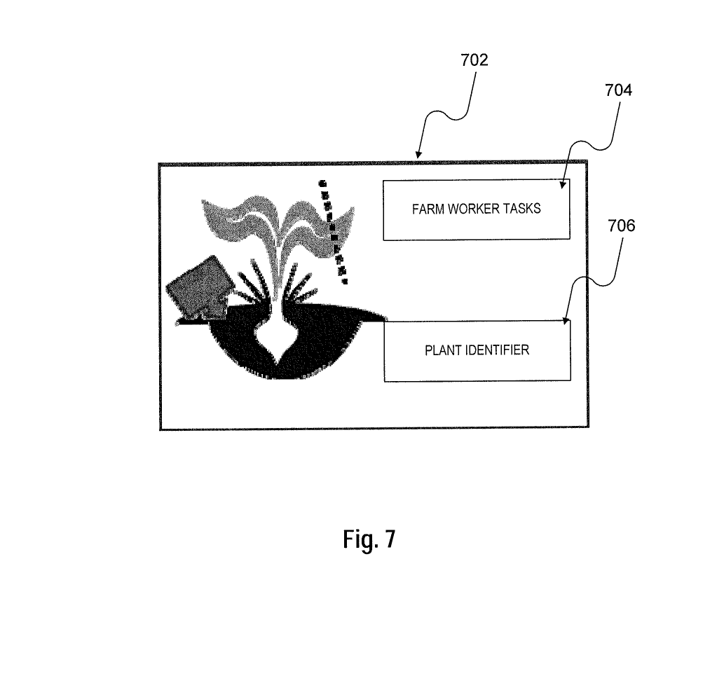

In step 216, instructions can be received to create a task instruction representing an action to be performed on the particularly plant. After a particular plant is selected, an image of the plant may be displayed as shown in FIG. 7. The plant may be displayed along with a user interface to prompt or facilitate the entry of tasks associated with the plant. The user may indicate instructions by, for example, selecting and modifying the image of the plant. For example, the user may draw a line on the display using a stylus or finger to indicate the type of pruning cut to be made on a plant. Alternatively, an input can be created indicating which portions of the plant require leaf movement to provide additional or less sunlight, water, fertilizer, or other plant maintenance. After the user has finished denoting the desired activity, the image is stored. The tasking image may be sent automatically and immediately to a field worker or may be queued up for retrieval by the field worker. The stored image may, for example, be displayed to the field worker when the worker is in proximity of the plant identifier. In some embodiments the instructions can be created online.

In step 218, a task instruction sets image can be transferred to a farm worker's mobile computing device. The task instruction may comprise, for example, an image with instructions. In some embodiments the instructions can be sent to the worker's mobile device, but they may not immediately be displayed.

In step 220, the instruction set images can be displayed in response to a farm worker's mobile device being in proximity to a plant identifier. The worker instruction screen pops up on the farm worker's mobile device, as the mobile device crosses into the field of view of a plant identifier. In some embodiments, a farm worker is presented with an image of the plant corresponding to a plant identifier as show in FIG. 3. In other embodiments, a farm worker's mobile device can display icons indicating a list of farm worker tasks. In certain embodiments a task can include adding water or chemicals to a plant. In other embodiments it can include pruning a certain portion of the plant as shown in FIG. 7.

After the farm worker has completed the instructions, an image of the plant with the executed task may be archived by a farm worker's mobile device in step 222. In some embodiments the image and executed task can be archived on the mobile collection unit. The database can be used for many farming assessments. Some of these are future plant yield predictions, management decisions such as labor time per plant and can assist with an accurate means to establish land value based on yields. There are many and well known to agricultural experts.

In other embodiments in which a plant is protected from ambient light sources under a hood or shading device, images corresponding to a biological imaging technique can be archived from a farm worker's mobile device or a camera collection unit, using a spectral filter.

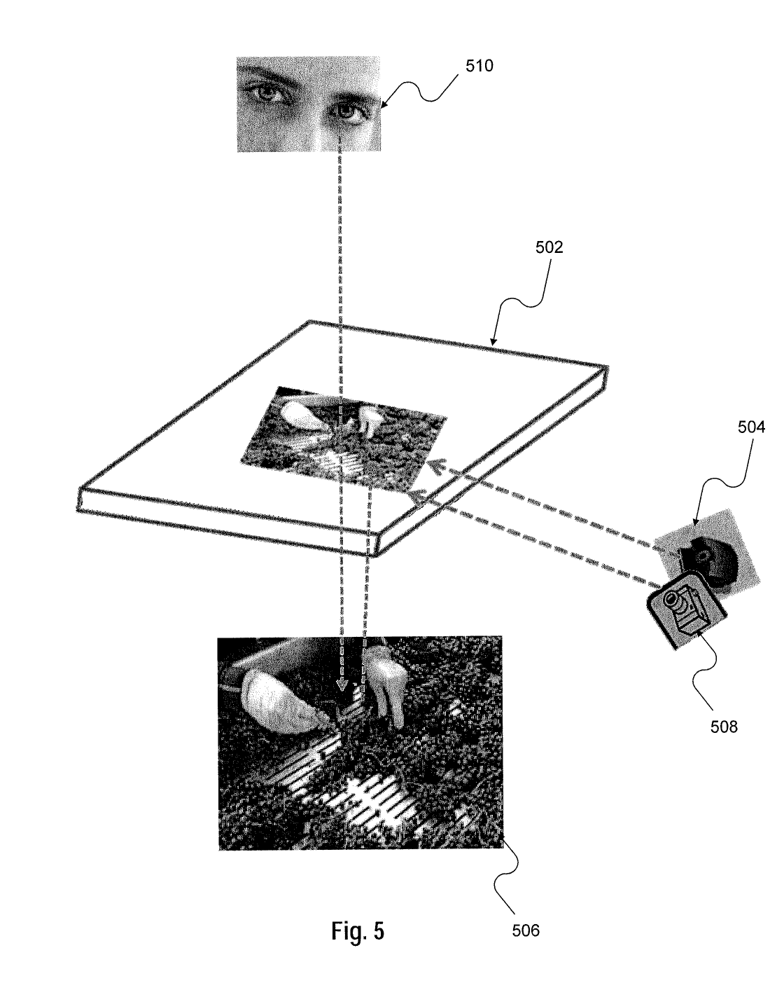

FIG. 5 is an exemplary image of a user viewing a crop on a sorting device such as a sorting table or conveyor belt and a projected image of the crop through a partial mirror. In some embodiments partial mirror 502 can allow a user to see a piece of fruit on a conveyor belt 506, and a qualitative biological data image of the fruit generated by projector 504. Images of the fruit can be projected onto partial mirror 502 so that the projected image aligns with the fruit. Alternatively the projected image can be superimposed with live camera views rendered with data such as reflectance or fluorescence imagery. Physical alignment of the optical path can include a bore-sighted camera 506 and projector 504. Point cloud, object identification or digital positioning techniques can also be used to co-register live images with live camera views. In some embodiments positioning sensors can be used such as distance measuring devices to achieve live registration of rendered data over a piece of fruit. Partial mirror 502 can be used to sort fruit by relative quality on conveyor belt 506. It will appreciated that conveyor belt 506 can also be a sorting table, or any other mechanical device that moves objects from one place to another, and that partial mirror 502 can be an transparent material that accomplishes the same task as partial mirror 502.

FIG. 7 is an exemplary image of a computing device displaying an image of a plant with task icons displayed on the image of the plant. Computing device 702 can display plant identifier 706 with a base image and farm worker tasks 704 menu. Plant identifier 706 can be the row and plant number and in some instances can be associated with a GPS position. A farm worker tasks menu 704 can be displayed on computing device 702 after input has been received to select a certain plant. Computing device 702 can display a farm worker tasks menu 704 that includes a set of maintenance tasks to be executed by a farm worker or robot that receives instructions for plant identifier 706.

In certain embodiments a mobile computing device application for point of purchase, can be used to select fruit with a certain level of ripeness, color, etc. A specific filter can be used over the lens of the camera or smart phone along with a flash generated by the mobile computing device and an image processing technique with objective identification to determine user defined fruit quality parameters. For example, a mobile computing device can obtain a base image without a flash, then obtain a second image with a filter corresponding to the parameter desired by the user. Using image processing techniques, and object identification program, and/or registration programs, subtraction or other image analysis, the two images can be rendered and superimposed on top of one another. The second image generated corresponding to the desired parameter can be colored for comparisons with other fruit to determine if other fruit contain more, less, or the same amount of the desired parameter. A color code can be created corresponding to each desired parameter.

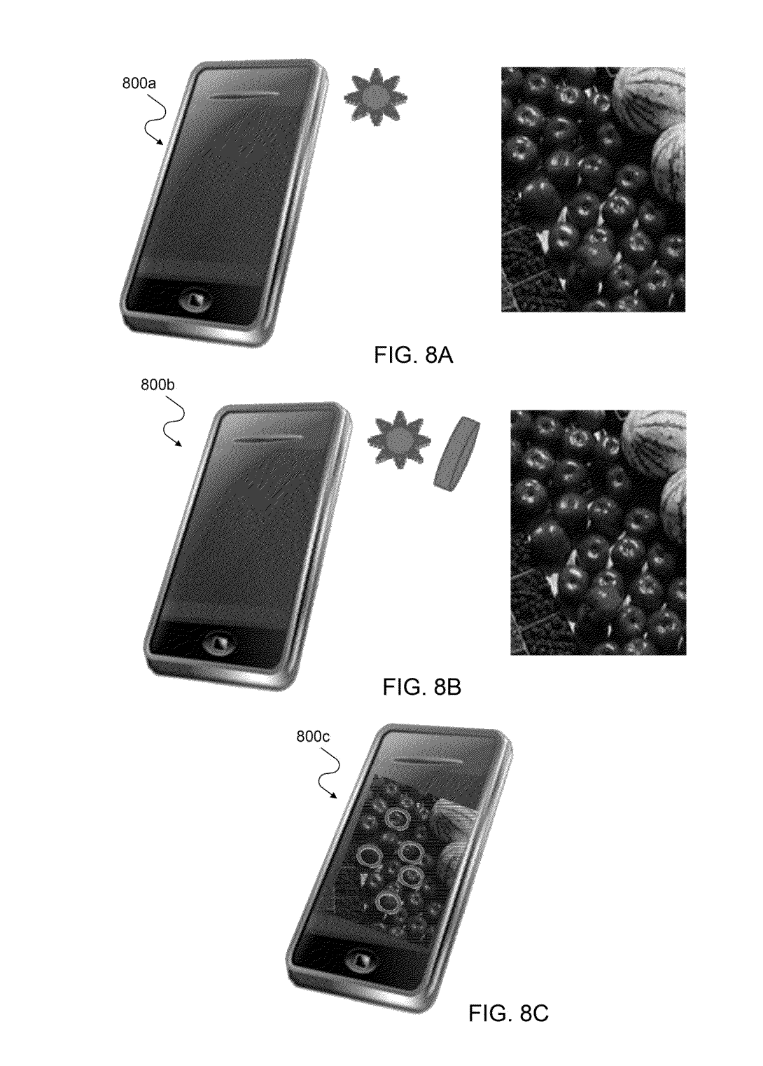

FIG. 8A is an exemplary image of a mobile computing device obtaining an image of a cluster of fruit. Mobile computing device 800a can take a base image of a cluster of fruit, without a filter, and store the image for background subtraction.

FIG. 8B is an exemplary image of a mobile computing device obtaining an image of a cluster of fruit with a filter. Mobile computing device 800b can take an image of a cluster of fruit with a three band filter for example. The image can be stored on for image registration and processing.

FIG. 8C is an exemplary image of a mobile computing device displaying an image of a cluster of fruit with icons. Mobile computing device 800c can have a program running that performs image processing including subtraction techniques after a base image has been taken with a filter, and the image has been registered and then comparing reflection levels in multiple narrow bands. Mobile computing device 800c can also place icons around fruit corresponding to certain reflectance properties. The icons can correspond to fruits that do have desired characteristics corresponding to a particular user biologic parameter.

Some or all of the methods disclosed herein can be implemented as a computer program product comprising computer-readable instructions. Computer-readable instructions and electronic data can be stored on a tangible non-transitory computer-readable medium, such as a flexible disk, a hard disk, a CD-ROM (compact disk-read only memory), an MO (magneto-optical) disk, a DVD-ROM (digital versatile disk-read only memory), a DVD RAM (digital versatile disk-random access memory), or a semiconductor memory. Alternatively, the methods can be implemented in hardware components or combinations of hardware and software of a data processing apparatus, e.g., a programmable processor, a computer, or multiple computers. The computer program can be written in any form of programming language, including compiled or interpreted languages, and it can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

What is claimed is:

1. A computer-implemented method for farming of crops on an individual plant basis, the method comprising:
identifying a plant and its location within a crop using a plant geolocation identifier technique, by which the geolocation of the plant may be determined;
capturing one or more current images of the plant by an imaging device;
associating one or more current images of the plant with the determined geolocation of the plant; and
rendering to a user a display comprising one or more current images of the plant and one or more previous images of the same plant, wherein previous images of the plant are accessed based on the determined geolocation.

2. The method of claim 1, wherein the one or more images of the plant are captured or displayed by the imaging device when it is determined that the imaging device is within proximity to an identified location identifier technique.

3. The method of claim 1 wherein the one or more images of the plant are captured from a point of view of a farm worker.

4. The method of claim 1 further comprising displaying task instructions to the user describing actions to be performed on the plant.

5. The method of claim 4, wherein the task instructions are automatically displayed on the user's display device when the display device is in proximity of a plant identifier.

6. The method of claim 1, further comprising:
acquiring and archiving an image of the plant after maintenance has been performed, wherein the image after maintenance is associated with the determined geolocation of the plant.

7. The method of claim 1 wherein the plant geolocation identifier technique is a barcode.

8. The method of claim 1 wherein the plant geolocation identifier technique is a RFID tag.

9. The method of claim 1 wherein the plant geolocation identifier technique allows the geolocation of the plant to be calculated or inferred using object identification software or point cloud techniques.

10. The method of claim 1 wherein the plant geolocation is calculated based on a geolocation position of a camera unit that considers the x,y,z pointing and ego motion of the camera platform.

11. The method of claim 1 further comprising displaying comparative biological information for the plant based on relative values rather than absolute values.

12. The method of claim 1 further comprising, generating an image result by performing a biological imaging technique and if desired image processing on one or more images.

13. The method of claim 11, further comprising calculating comparative thresholds of the image result of the biological imaging technique.

14. The method of claim 1 wherein the rendered image can be displayed on a transparent display.

15. The method of claim 14 wherein the transparent display is a partial mirror.

16. The method of claim 14 wherein the transparent display is eyewear.

17. A system for farming of crops on an individual plant basis, the system comprising:
a geolocation device for identifying a plant and its location within a crop using a plant geolocation identifier technique, by which the geolocation of the plant may be determined;
an imaging device for capturing one or more current images of the plant;
a processor for associating one or more current images of the plant with the determined geolocation of the plant; and
a display device for rendering to a user a display comprising one or more current images of the plant and one or more previous images of the same plant, wherein previous images of the plant are accessed based on the determined geolocation.

18. The system of claim 17 wherein the display is a transparent display.

19. The method of claim 18 wherein the transparent display is a partial mirror.

20. The method of claim 18 wherein the transparent display is eyewear.
